(19) United States
(12) Patent Application Publication
(10) Pub. No.: US 2007/0189232 A1
(43) Pub. Date: Aug. 16, 2007

(54) Method and system for data packer unit for accelerating stack functions

(76) Inventors: Li Fung Chang, Holmdel, NJ (US); Ajat Hukkoo, Cupertino, CA (US)

Correspondence Address: MCANDREWS HELD & MALLOY, LTD, 500 WEST MADISON STREET, SUITE 3400, CHICAGO, IL, 60661, US

(21) Appl. No.: 11/353,889

(22) Filed: Feb. 14, 2006

(51) Int. Cl. H04B 7/216

(52) U.S. Cl. 370/335

(57) ABSTRACT

Methods and systems for data packer unit for accelerating stack functions may include packing payload bits for HSDPA packets in sequence, in hardware, for example, a multistage pipeline, to form a data packet. The data packet may be aligned to start on a n-bit boundary, regardless of a bit position of the start of one or more of the payloads. The value of n may be a multiple of 8, such as, for example, 32. Bits, which may be zeros, for example, may be inserted to end of the data packet to pad the data packet to an n-bit boundary. The HSDPA packets may be fetched from memory, for example, by using variable burst DMA. The information to fetch the HSDPA packets may be stored, for example, in a linked list. The operation of packing the payloads from the fetched HSDPA packets may be controlled via a state machine.

### CROSS-REFERENCE TO RELATED APPLICATIONS/INCORPORATION BY REFERENCE

This application makes reference to U.S. application Ser. No. ______ (Attorney Docket No. 17261 US01) filed on even date herewith.

The above stated application is hereby incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

Certain embodiments of the invention relate to processing data in a communication system. More specifically, certain embodiments of the invention relate to a method and system for a data packer unit for accelerating stack functions.

### BACKGROUND OF THE INVENTION

Mobile communication has changed the way people communicate and mobile phones have been transformed from a luxury item to an essential part of every day life. The use of mobile phones today is generally dictated by social situations, rather than being hampered by location or technology. While voice connections fulfill the basic need to communicate, and mobile voice connections continue to filter even further into the fabric of every day life, the mobile Internet is the next step in the mobile communication revolution. The mobile Internet is poised to become a common source of everyday information, and easy, versatile mobile access to this data will be taken for granted.

Third generation (3G) cellular networks have been specifically designed to fulfill these future demands of the mobile Internet. As these services grow in popularity and usage, factors such as cost efficient optimization of network capacity and quality of service (QoS) will become even more essential to cellular operators than it is today. These factors may be achieved with careful network planning and operation, improvements in transmission methods, and advances in receiver techniques. To this end, carriers need technologies that will allow them to increase downlink throughput and, in turn, offer advanced QoS capabilities and speeds that rival those delivered by cable modem and/or DSL service providers. In this regard, networks based on wideband CDMA (WCDMA) technology may make the delivery of data to end users a more feasible option for today's wireless carriers.

The General Packet Radio Service (GPRS) and Enhanced Data rates for GSM (EDGE) technologies may be utilized for enhancing the data throughput of present second generation (2G) systems such as GSM. The GSM technology may support data rates of up to 14.4 kilobits per second (Kbps), while the GPRS technology may support data rates of up to 115 Kbps by allowing up to 8 data time slots per time division multiple access (TDMA) frame. The GSM technology, by contrast, may allow one data time slot per TDMA frame. The EDGE technology may support data rates of up to 384 Kbps. The EDGE technology may utilizes 8 phase shift keying (8-PSK) modulation for providing higher data rates than those that may be achieved by GPRS technology. The GPRS and EDGE technologies may be referred to as “2.5G” technologies.

The UMTS technology with theoretical data rates as high as 2 Mbps, is an adaptation of the WCDMA 3G system by GSM. One reason for the high data rates that may be achieved by UMTS technology stems from the 5 MHz WCDMA channel bandwidths versus the 200 KHz GSM channel bandwidths. The HSDPA technology is an Internet protocol (IP) based service, oriented for data communications, which adapts WCDMA to support data transfer rates on the order of 10 megabits per second (Mbits/s). Developed by the 3G Partnership Project (3GPP) group, the HSDPA technology achieves higher data rates through a plurality of methods. For example, many transmission decisions may be made at the base station level, which is much closer to the user equipment as opposed to being made at a mobile switching center or office. These may include decisions about the scheduling of data to be transmitted, when data is to be retransmitted, and assessments about the quality of the transmission channel. The HSDPA technology may also utilize variable coding rates. The HSDPA technology supports 16-level quadrature amplitude modulation (16-QAM) over a high-speed downlink shared channel (HS-DSCH), which permits a plurality of users to share an air interface channel

In some instances, HSDPA may provide a two-fold improvement in network capacity as well as data speeds up to five times (over 10 Mbit/s) higher than those in even the most advanced 3G networks. HSDPA may also shorten the roundtrip time between network and terminal, while reducing variances in downlink transmission delay. These performance advances may translate directly into improved network performance and higher subscriber satisfaction. Since HSDPA is an extension of the GSM family, it also builds directly on the economies of scale offered by the world's most popular mobile technology. HSDPA may offer breakthrough advances in WCDMA network packet data capacity, enhanced spectral and radio access networks (RAN) hardware efficiencies, and streamlined network implementations. Those improvements may directly translate into lower cost-per-bit, faster and more available services, and a network that is positioned to compete more effectively in the data-centric markets of the future.

The capacity, quality and cost/performance advantages of HSDPA yield measurable benefits for network operators, and, in turn, their subscribers. For operators, this backwards-compatible upgrade to current WCDMA networks is a logical and cost-efficient next step in network evolution. When deployed, HSDPA may co-exist on the same carrier as the current WCDMA Release 99 services, allowing operators to introduce greater capacity and higher data speeds into existing WCDMA networks. Operators may leverage this solution to support a considerably higher number of high data rate users on a single radio carrier. HSDPA makes true mass-market mobile IP multimedia possible and will drive the consumption of data-heavy services while at the same time reducing the cost-per-bit of service delivery, thus boosting both revenue and bottom-line network profits. For data-hungry mobile subscribers, the performance advantages of HSDPA may translate into shorter service response times, less delay and faster perceived connections. Users may also download packet-data over HSDPA while conducting a simultaneous speech call.

HSDPA may provide a number of significant performance improvements when compared to previous or alternative technologies. For example, HSDPA extends the WCDMA bit rates up to 10 Mbps, achieving higher theoretical peak rates with higher-order modulation (16-QAM) and with adaptive coding and modulation schemes. The maximum QPSK bit rate is 5.3 Mbit/s and 10.7 Mbit/s with 16-QAM. Theoretical bit rates of up to 14.4 Mbit/s may be achieved with no channel coding. The terminal capability classes range from 900 kbit/s to 1.8 Mbit/s with QPSK modulation, and 3.6 Mbit/s and up with 16-QAM modulation. The highest capability class supports the maximum theoretical bit rate of 14.4 Mbit/s.

However, implementing advanced wireless technologies such as WCDMA and/or HSDPA may still require overcoming some architectural hurdles because of the very high-speed, wide bandwidth data transfers possible. For example, multiple-input multiple-output (MIMO) antenna architectures, and multipath processing receiver circuitry may be implemented to process the high speed, high bandwidth received RF signals to digital data. But, with the high speed, wide bandwidth access to, for example, the Internet, made possible by HSDPA, various protocol handlers at a mobile terminal may have problems in keeping up with the received packets.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method for a data packer unit for accelerating stack functions, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1a illustrates an exemplary High Speed Downlink Packet Access (HSDPA) distributed architecture, which may be utilized in connection with an embodiment of the invention.

FIG. 1b is a block diagram of an exemplary RF receiver system, which may be utilized in connection with an embodiment of the invention.

FIG. 2a is a high-level block diagram of exemplary circuitry that comprises data packing circuitry, in accordance with an embodiment of the invention.

FIG. 2b is a diagram of exemplary PDUs that are packed, in accordance with an embodiment of the invention.

FIG. 3 is a diagram of an exemplary configuration register for data packing circuitry, in accordance with an embodiment of the invention.

FIG. 4 is a diagram of an exemplary data structure for linked lists for data packing circuitry, in accordance with an embodiment of the invention.

FIG. 5 is an exemplary flow diagram for operation of data packing circuitry, in accordance with an embodiment of the invention.

FIG. 6 is a diagram illustrating exemplary pipeline stages for packing data without stalling, in accordance with an embodiment of the invention.

FIG. 7 is a diagram illustrating exemplary pipeline stages for packing data with stalls, in accordance with an embodiment of the invention.

### DETAILED DESCRIPTION OF THE INVENTION

Certain embodiments of the invention may be found in a method and system for a data packer unit for accelerating stack functions. Aspects of the method may comprise packing payload bits for HSDPA packets in sequence, in hardware, to form a packed data packet. The hardware may comprise, for example, a multistage pipeline. The packed data packet may be aligned so that it starts on a n-bit boundary, regardless of a bit position of start of each of the payloads. The value of n may be a multiple of 8. For example, the value of n may be 32 in system that may utilize a 32-bit word. Bits may be inserted to end of the data packet to pad the data packet to an n-bit boundary. The inserted bits may comprise, for example, zeros.

The HSDPA packets may be fetched from memory using, for example, direct memory access. The data fetches may be via a variable sized burst accesses. The information to fetch the HSDPA packets may be stored, for example, in a linked list. The operation of packing the payloads from the fetched HSDPA packets may be controlled in hardware via, for example, a state machine. A packed n-bit word may be generated in at least one state period of the state machine. A state period may comprise either one-half of one clock period or one clock period. This may depend on whether the state machine uses only rising edges or falling edges of a clocking signal, or the state machine uses both rising edges and falling edges.

Generally, a packed word may be generated per state period. However, when a first HSDPA packet is processed, there may be several state periods during which a packed n-bit word may not be generated. There may be other periods of time during which n-bit packed words may not be generated per state period. This may be referred to as a stall. A stall may occur in instances when the payloads in two consecutive HSDPA packets may not have enough valid bits to form a n-bit word.

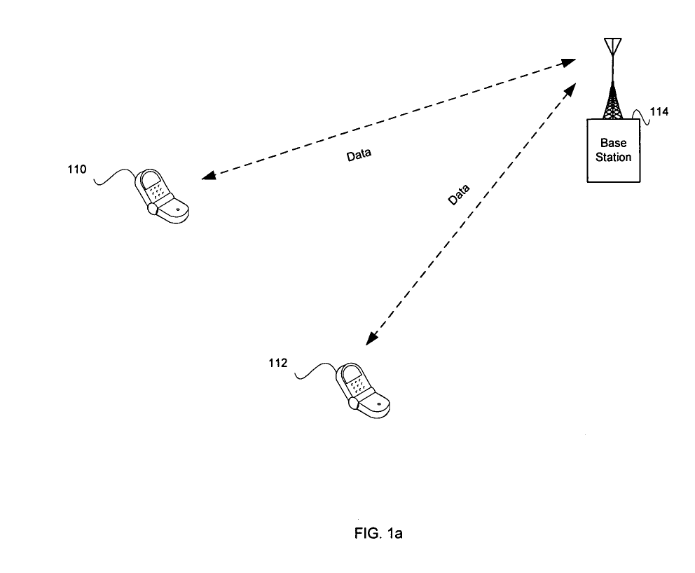

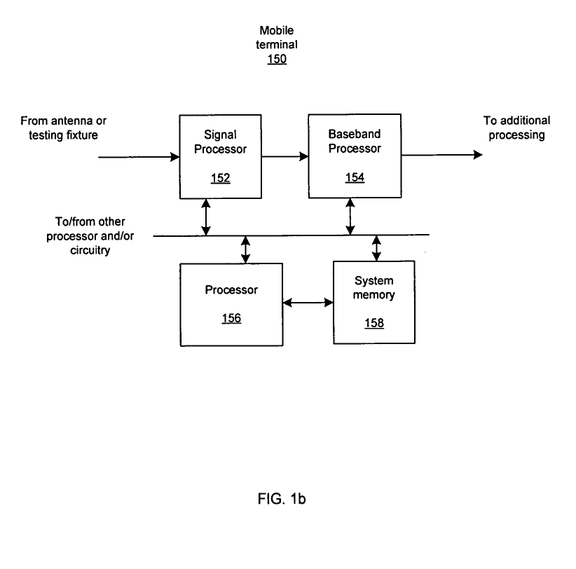

FIG. 1a illustrates an exemplary HSDPA distributed architecture, which may be utilized in connection with an embodiment of the invention. Referring to FIG. 1a, there is shown terminals 110 and 112 and a base station (BS) 114. HSDPA is built on a distributed architecture that may achieve low delay link adaptation by placing key processing at the BS 114 and thus closer to the air interface as illustrated. HSDPA leverages methods that are well established within existing GSM/EDGE standards to deliver significantly improved packet data throughput performance between the mobile terminals 110 and 112 and the BS 114.

The HSDPA technology employs several important new technological advances. Some of these may comprise scheduling for the downlink packet data operation at the BS 114, higher order modulation, adaptive modulation and coding, hybrid automatic repeat request (HARQ), physical layer feedback of the instantaneous channel condition, and a new transport channel type known as high-speed downlink shared channel (HS-DSCH) that allows several users to share the air interface channel. When deployed, HSDPA may co-exist on the same carrier as the current WCDMA and UMTS services, allowing operators to introduce greater capacity and higher data speeds into existing WCDMA networks. HSDPA replaces the basic features of WCDMA, such as variable spreading factor and fast power control, with adaptive modulation and coding, extensive multicode operation, and fast and spectrally efficient retransmission strategies.

FIG. 1b is a block diagram of an exemplary RF receiver system, which may be utilized in connection with an embodiment of the invention. Referring to FIG. 1b, there may be shown a portion of a mobile terminal 150 that may comprise a signal processor block 152, a baseband processor block 154, a processor 156, and a system memory 158. The signal processor block 152 may comprise suitable logic, circuitry, and/or code that may be adapted for receiving RF signals. The signal processor block 152 may be coupled to an external antenna for signal reception. The signal processor block 152 may demodulate a received signal before further processing. Moreover, the signal processor block 152 may comprise other functions, for example, filtering the received signal, amplifying the received signal, and/or downconverting the received signal to an analog baseband signal. The signal processor block 152 may also digitize the analog baseband signal to a digital baseband signal, and digitally process the digital baseband signal, for example, to filter the digital baseband signal.

The baseband processor block 154 may comprise suitable logic, circuitry, and/or code that may be adapted for processing the digital baseband signals communicated by the signal processor block 152. The processor 156 may comprise suitable logic, circuitry, and/or code that may be adapted for controlling the operations of the signal processor block 152 and/or the baseband processor block 154. For example, the processor 156 may be utilized to update and/or modify programmable parameters and/or values in a plurality of components, devices, and/or processing elements that may be in the signal processor block 152 and/or the baseband processor block 154. For example, there may be programmable gain amplifiers in the signal processor block 152. The processor 156 may also process data received from the baseband processor 154.

Accordingly, the processor 156 may off-load some processing of the data from the baseband processor 154 by, for example, other processors or hardware circuitry. Additionally, the processor 156 may store data received from the baseband processor 154 in the system memory 158. The baseband processor 154 may also comprise direct memory access (DMA) circuitry that may enable storing data directly from the baseband processor 154 to the system memory 158. FIG. 1b may be one exemplary architecture for a portion of the mobile terminal 150. Other architectures may also be used in connection with an embodiment of the invention.

The processor 156 may determine the mode of operation of the signal processor block 152. For example, the processor 156 may select a specific frequency for a local oscillator, or a specific gain for a variable gain amplifier. Moreover, the specific frequency selected and/or parameters needed to calculate the specific frequency, and/or the specific gain value and/or the parameters needed to calculate the specific gain, may be stored in the system memory 158 via the processor 156. This information stored in system memory 158 may be transferred to the signal processor block 152 from the system memory 158 via the processor 156. The system memory 158 may comprise suitable logic, circuitry, and/or code that may be adapted for storing a plurality of control and/or data information, including parameters needed to calculate frequencies and/or gain, and/or the frequency value and/or gain value.

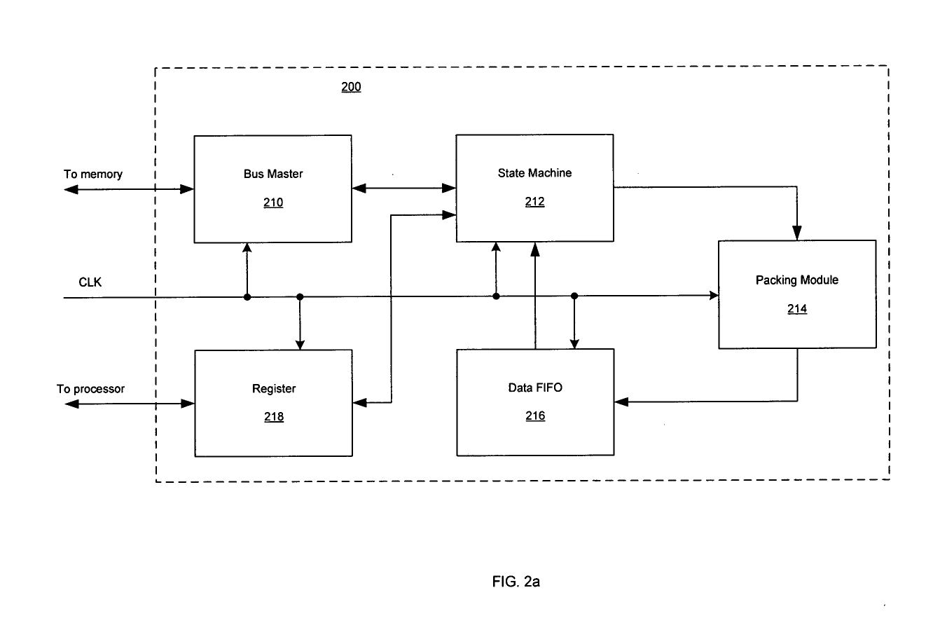

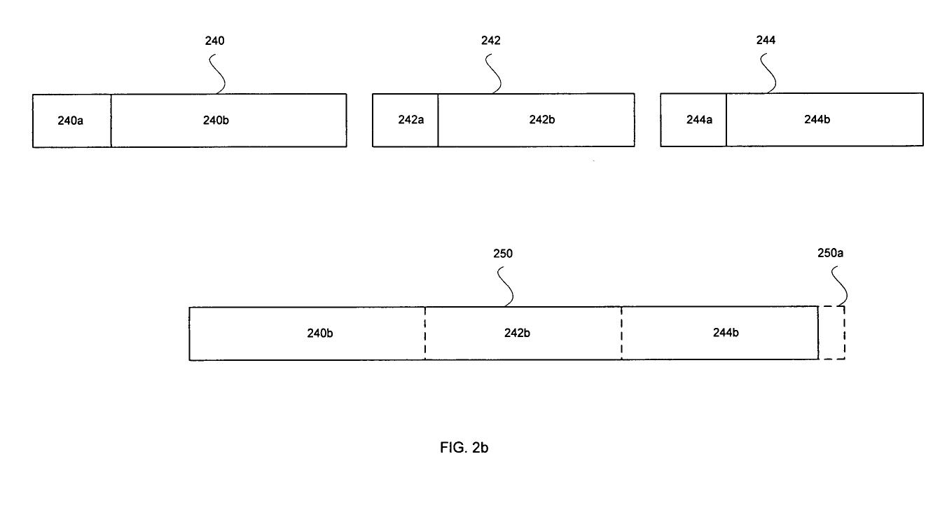

FIG. 2a is a high-level block diagram of exemplary circuitry that comprises data packing circuitry, in accordance with an embodiment of the invention. Referring to FIG. 2, there is shown a data packing block 200 that comprises a bus master block 210, a state machine block 212, a packing module 214, a data FIFO block 216, and a register block 218. The bus master block 210 may comprise suitable circuitry, logic, and/or code that may enable transferring of data between the state machine block 212 and other devices, such as, for example, the system memory 158, and/or the processor 156. In this regard, the bus master block 210 may be, for example, a DMA processor.

The state machine block 212 may comprise suitable circuitry and/or logic that may enable controlling of packing payload portion of at least one packet data unit (PDU). A PDU may be received HSDPA packet, for example. The inputs to the state machine block 212 may comprise, for example, data from the register block 218, an indication of whether the packing module 214 is stalled, whether there are any more words in a PDU remaining to be packed, and whether there are any more PDUs to pack.

The packing module 214 may comprise suitable circuitry and/or logic that may enable generation of packed data packet by removing header information from a PDU and transferring a remaining payload information to the data FIFO block 216. The packed data packet in the data FIFO block 216 may be stored in memory, for example, the system memory 158.

The data FIFO block 216 may comprise suitable circuitry and/or logic that may enable storing packed data originating from the packing module 214 to the system memory 158. For example, packed data originating from the packing module 214 may be stored in the system memory 158 by burst transfers.

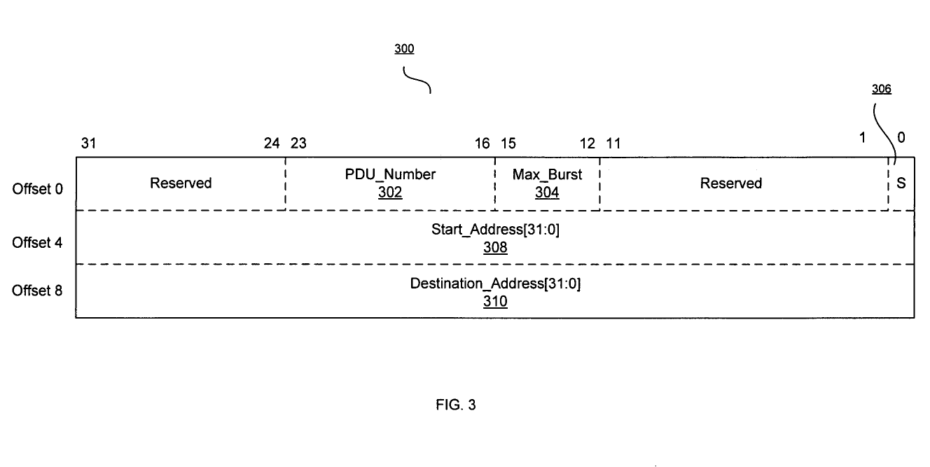

The register block 218 may comprise suitable circuitry and/or logic that may enable storing of information that may be used for packing data by the state machine block 212. For example, a processor such as the processor 156 may store the number of PDUs that need to be packed in to a packed data packet, the address of the first linked list element that may have information on the first PDU to be packed, and the destination address at which to store the packed data packet. The information in the register block 218 may be described in more detail with respect to FIG. 3.

In operation, a processor, for example, the processor 156, may store information about a plurality of PDUs that need to be packed in to the register block 218. The processor 156 may then assert a start field in the register block 218. The asserted start field may indicate to the state machine block 212 to start packing the data in the PDUs. The state machine block 212 may poll the start field in the register block 218 to find out when it is asserted. Alternatively, when the start field is asserted, an interrupt may be generated. Other embodiments of the invention may buffer an output of the start field and communicate the buffered output to an input of the state machine block 212.

A clock signal CLK may be communicated to the bus master block 210, the state machine block 212, the packing module 214, the data FIFO block 216, and/or the register block 218, to provide timing signals. A rising edge and/or a falling edge of the clock signal may be used for timing. Accordingly, a state period may be substantially one-half of the clock signal period if both the rising edges and the falling edges are used. If only the rising edges or only the falling edges are used, the state period may be one clock period.

The state machine block 212 may generate various control signals that may enable fetching of PDUs from, for example, the system memory 158. The headers of the PDUs may be removed and the remaining payload of the PDUs may be packed together by the packing module block 214. The packed data may be transferred to the data FIFO block 216 as, for example, 32-bit words. The packed data packet may be aligned to start on a 32-bit word boundary. The data FIFO block 216 may store a plurality of the words, and then burst write the words to the system memory at the indicated address in the register block 218. When the payloads in all of the PDUs have been packed, the state machine block 212 may de-assert the start field in the register block 218. The end of the packed data packet may also be padded, by zeros, for example, to align the end of the packed data packet with a word boundary, for example, a 32-bit word boundary.

Although an embodiment of the invention with specific functionalities for different modules may have been described, the invention need not be so limited. Other embodiments of the invention may separate the overall invention, which generates a packed data packet on a 32-bit boundary from PDUs that may have headers on bit boundaries, in to different functional groups. For example, another embodiment of the invention may group the packing module block 214 and the data FIFO block 216 together. Additionally, other embodiments of the invention may use word sizes and boundaries other than 32 bits. For example, the word size and/or boundaries used may be 64 bits.

Additionally, the bus master block 210 may interface to other memory blocks in addition to, or in place of, the system memory 158. Also, the register block 218 may be controlled by another processor than the processor 156. These architectural considerations may be design and/or implementation dependent.

FIG. 2b is a diagram of exemplary PDUs that are packed, in accordance with an embodiment of the invention. Referring to FIG. 2b, there is shown PDUs 240, 242, and 244, and a packed data packet 250. The PDUs 240, 242, and 244 may comprise a header and a payload. The headers may be 240a, 242a, and 244a and the payloads may be 240b, 242b, and 244b. The packed data packet 250 may comprise payloads 240b, 242b, and 244b. The packed data packet 250 may be stored in memory at, for example, a 32-bit aligned address. Additionally, if the payloads 240b, 242b, and 244b are not a multiple of 32-bits of data, a padding 250a may be used so that the packed data packet 250 may end on a word boundary such as a 32-bit word 32-bit boundary. The padding 250a may comprise, for example, zeros.

FIG. 3 is a diagram of an exemplary configuration register for data packing circuitry, in accordance with an embodiment of the invention. Referring to FIG. 3, there is shown a configuration register 300 that may comprise three 32-bit words. The configuration register 300 may be, for example, a portion of the register block 218. The three 32-bit words may have offsets of zero bytes, 4 bytes and 8 bytes with respect to the start of the configuration register 300.

The configuration register 300 may comprise, for example, an 8-bit PDU_Number field 302, a 4-bit Max_Burst field 304, a 1-bit Start field 306, a 32-bit Source_Address field 308, and a 32-bit Destination_Address field 310. The invention need not be limited to fields of these numbers of bits. The number of bits allocated to a field may be dependent on a design of an embodiment of the invention. Other bits in the configuration register 300 that may not be assigned presently may be reserved and utilized later.

The PDU_Number field 302 may hold the number of packet data units (PDU), or packets or data blocks, that may need to be assembled, or packed, to form a single packed data packet. Accordingly, the 8-bit PDU_Number field 302 may allow up to 256 PDUs, or data blocks, to be assembled together. Max_Burst field 304 may hold the number of words that may be burst transferred to and/or from memory, for example, the system memory 158. Some embodiments of the invention may be limited to a specific burst, for example, bursts of 4, 8, or 16 words, where each word may be 32 bits in length. Accordingly, valid entries for the Max_Burst field 304 may be 4, 8, and 16. As an example, if there are 31 words to be transferred for a PDU, the Max_Burst field 304 may be set to 16. The 31 words may then be transferred in a burst of 16 words, then a burst of 8 words, then a burst of 4 words, then with three single word transfers.

The Start field 306 may be asserted when the configuration register 300 is completed and PDUs that may be packed are available in memory, for example, the system memory 158. The state machine block 212 may poll this field, and when it is asserted, may start packing the indicated PDUs. When the state machine block 212 completes packing the PDUs, the state machine block 212 may deassert this field. Although an implementation of the invention may use polling to find the status of the Start field 306, the invention need not be so limited. For example, assertion of the Start field 306 may initiate an interrupt process, or the output of the Start field 306 may be coupled, via buffering circuitry if needed, to the state machine block 212.

If an interrupt based system is supported, a field may be dedicated so that when it is asserted, it may indicate that an interrupt is being used. When the interrupt field is de-asserted, the state machine block 212 may poll the Start field 306. Additionally, some implementation of the invention may support both “big-endian” and “little-endian” formats of data addressing. Accordingly, a field may be necessary to indicate whether big-endian or little-endian format is used. These additional fields may be single bit fields, and may use two bits in the reserved fields.

For a 32-bit word in a big-endian format at, for example, address 0x00, the most significant byte may be at address 0x00. The next most significant byte may be at address 0x01, and the next most significant byte may be at address 0x02. The least significant byte may be at address 0x03. For a 32-bit word in a little-endian format at, for example, address 0x00, the least significant byte may be at address 0x00. The next least significant byte may be at address 0x01, and the next least significant byte may be at address 0x02. The most significant byte may be at address 0x03.

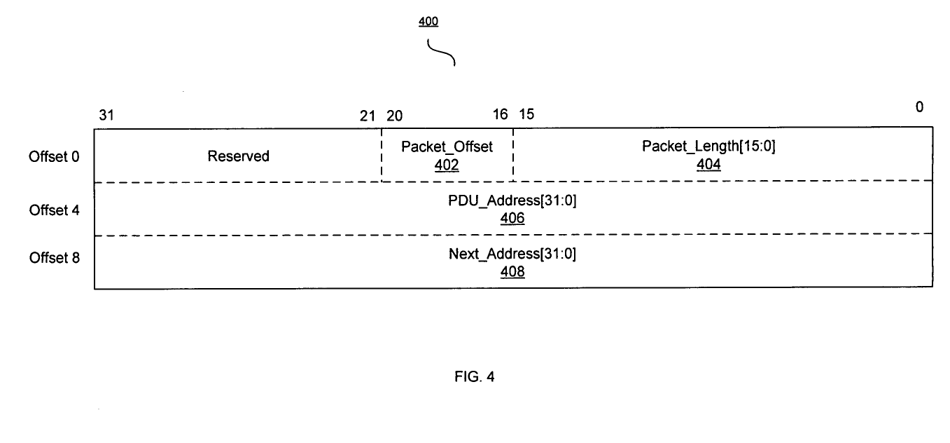

The Source_Address field 308 may hold an address of a first element of a linked list. The data in the elements of the linked list may provide information for accessing the PDUs that may need to be packed. The link list data structure may be described in more detail with respect to FIG. 4. The Destination_Address field 310 may hold a start address of memory where the packed data packet may be stored.

In operation, a processor, for example, the processor 156, may program values into the configuration register 300 fields such as the PDU_Number field 302, the Max_Burst field 304, the Source_Address field 308, and the Destination_Address field 310. After programming these fields, the processor 156 may assert the Start field 306. Asserting the Start field 306 may indicate to the state machine block 212 to fetch information in the Source_Address field 308. This information may be parsed to fetch data in the payload of the first PDU. Part of the information in the Source_Address field 308 may indicate the next element of the linked list, which may provide information on the next PDU that may need to be packed. Payloads in subsequent PDUs may be fetched and packed until the payloads in the number of PDUs indicated in the PDU_Number field 302 have been fetched and packed.

The data packed by the packing module 214 may be transferred to the data FIFO block 216 as part of the packing process. The packed data may be transferred to the portion of memory that may be allocated to store the packed data packet. When data from the last PDU has been packed, the state machine block 212 may de-assert the Start field 306. Accordingly, the configuration register 300 may be programmed with information for a new set of PDUs that may need to be packed.

FIG. 4 is a diagram of an exemplary data structure for linked lists for data packing circuitry, in accordance with an embodiment of the invention. Referring to FIG. 4, there is shown a linked list data structure 400 that may comprise three 32-bit words. The linked list data structure 400 may be implemented, for example, in the system memory 158. The three 32-bit words may have offsets of zero bytes, 4 bytes and 8 bytes with respect to the start of the linked list data structure 400.

The linked list data structure 400 may comprise, for example, a 5-bit Packet_Offset field 402, a 16-bit Packet_Length field 404, a 32-bit PDU_Address field 406, and a 32-bit Next_Address field 408. The invention need not be limited to fields of these numbers of bits. The number of bits allocated to a field may be dependent on a design of an embodiment of the invention. Other bits in the linked list data structure 400 that may not be assigned presently may be reserved.

The Packet_Offset field 402 may hold the number of bits that a payload in a PDU is offset from start of the PDU. Since this is a 5-bit field, the offset may range from 0 to 31 bits. A PDU that is on a 32-bit boundary, for example, because the header is 32 bits long, may have an offset value of 0 in the Packet_Offset field 402. The Packet_Length field 404 may hold the number of bits in the PDU. Since the field may hold a 16-bit value, the maximum number of bits in a PDU may be 64K bits, or 8K bytes.

The PDU_Address field 406 may hold the start address of the memory location where the PDU may be stored. The 32-bit Next_Address field 408 may store the start address of the next element in the linked list. Accordingly, when the Start field 306 is asserted, the state machine block 212 may fetch the address in the Start_Address field 308. The state machine block 212 may then fetch information in the linked list element at the address in the Start_Address field 308. This information may be parsed to fetch data at the address in the PDU_Address field 406. The number of bits to be skipped at the beginning of the fetched data may be indicated by the value in the Packet_Offset field 402. The packing module 214 may then pack the data by moving the remaining data to the beginning of a 32-bit boundary. The packing module 214 may store the number of bits specified by the Packet_Length field 404 before fetching the next PDU.

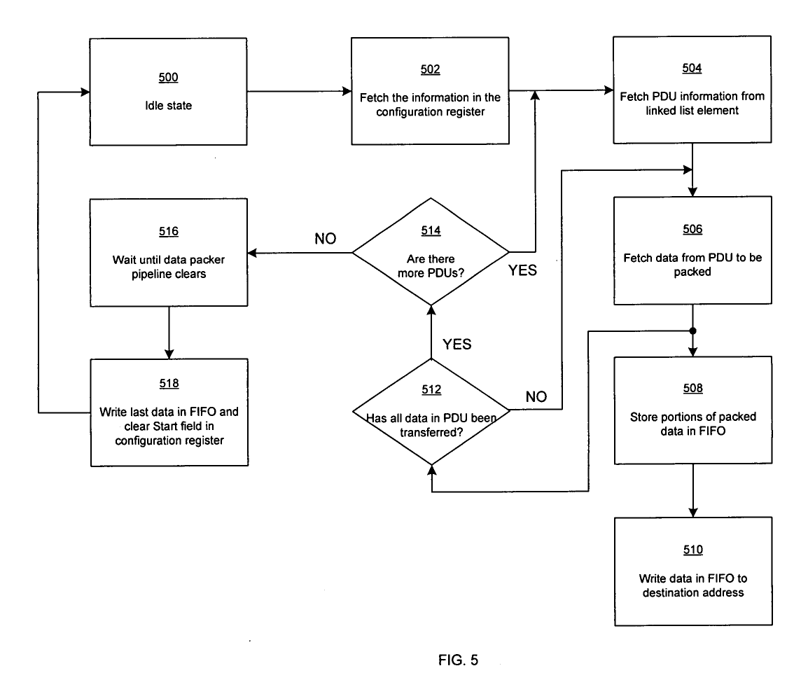

The information for the next PDU may be in the next linked list element that may be at the address stored in the Next_Address field 408. The linked list element may be fetched and the PDU information in the linked list element may be processed to skip the header portion, and then to pack the data portion of the current PDU to the data from the previous PDU. This process may continue until the number of PDUs that need to be packed, as indicated in the PDU_Number field 302, have been packed. Examples of the packing process may be described in more detail with respect to FIGS. 5, 6, and 7.

FIG. 5 is an exemplary flow diagram for operation of data packing circuitry, in accordance with an embodiment of the invention. Referring to FIG. 5, there may be shown steps 500 to 518. The step 500 may be an idle state. This may be, for example, when the Start field 306 of the configuration register 300 may be unasserted. When the Start field 306 is asserted, the next step may be step 502. In step 502, the state machine block 212 may fetch the information in the configuration register. In step 504, the state machine block 212 may fetch PDU information from a linked list element. The first linked list element may be pointed to by the Start_Address field 308 of the configuration register 300. The Next_Address field 408 in the present linked list element may point to a subsequent linked list element.

In step 506, data may be fetched from the PDU pointed to by the PDU_Address field 406 in the linked list element. The next step may be steps 508 and 512. In step 508, the packing module 214 may pack data that may have been fetched in step 506. In step 510, packed data may be transferred to the data FIFO block 216. The number of words of packed data that may be transferred may be the number of words that may be indicated to be burst transferred with respect to the Max_Burst field 304. Whether the packed data may be transferred may be determined by the number of packed words that may be in the data FIFO block 216 after data from the PDU being packed has been fetched. If the number of packed words in the data FIFO block 216 exceeds the number of burst transfers allowed, a burst transfer of the packed words in the data FIFO block 216 may be transferred to memory. The packed words may be stored in the memory location indicated by the address in the Destination_Address field 310.

In step 512, the state machine block 212 may determine whether all data in the present PDU may have been transferred. If so, the next step may be step 514. If not, the next step may be step 506. In step 514, the state machine block 212 may determine whether there may be any more PDUs to pack. If so, the next step may be step 504. If not, the next step may be step 516. In step 516, the data FIFO block 216 may be filled with remaining packed data from the last PDU in the data packer module 214. In step 518, all of the packed data in the data FIFO block 216 may be stored in memory. Additionally, since all of the PDUs may have been packed, the state machine block 212 may de-assert the Start field 306. The next step may be step 500, the idle state.

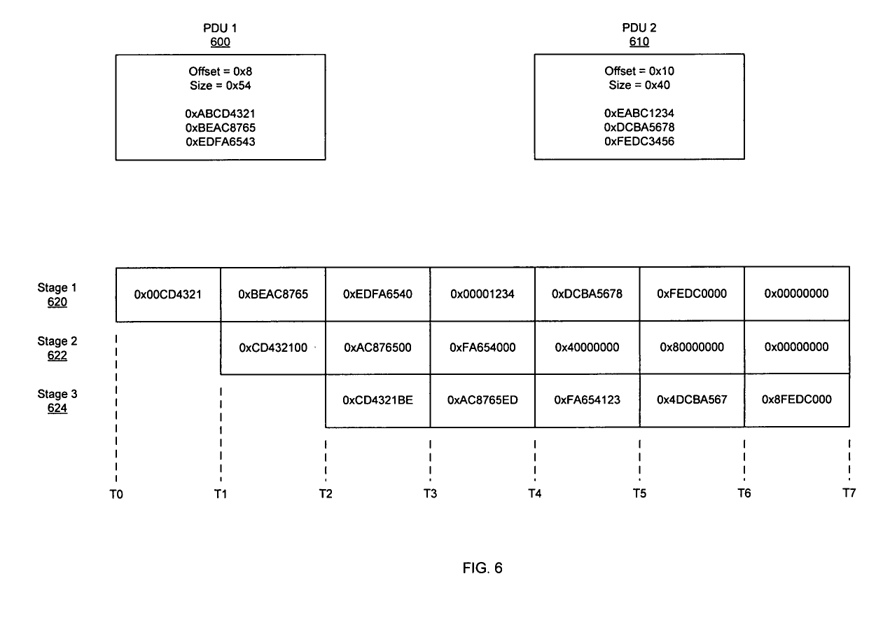

FIG. 6 is a diagram illustrating exemplary pipeline stages for packing data without stalling, in accordance with an embodiment of the invention. Referring to FIG. 6, there is shown a first PDU 600, a second PDU 610, and three pipeline stages 620, 622, and 624. The pipeline stages 620, 622, and 624 may be a portion of the packing module 214. There is also shown time instants T0, . . . , T7 at which various actions may occur with respect to the pipeline stages 620, 622, and 624. These time instants may be, for example, rising edges and/or falling edges of clock signals. Accordingly, a state period may be from one time instant to the next time instant, for example, from the time instant T0 to the time instant T1.

In an exemplary embodiment of the invention, the first PDU 600 may comprise three 32-bit words, where the most significant word may be 0xABCD_{—}4321, the second word may be 0xBEAC_{—}8765, and the least significant word may be 0xEDFA_{—}6543. The underscore is placed after every 4 nibbles for ease of reading the hexadecimal characters and has no other significance. The offset may be 8 bits, or 2 nibbles, where these 8 bits may be, for example, header information for the first PDU 600. The length of the payload in the first PDU 600 may be 84 bits. Accordingly, the packed data of the first PDU 600 may comprise the 6 least significant nibbles of the most significant word, the next word, and the 7 most significant nibbles of the last word. The packed data may be 84 bits in length, 0xCD43_{—}21 BE_AC87_{—}65ED_FA65_{—}4.

The second PDU 610 may also comprise three 32-bit words, where the most significant word may be 0xEABC_{—}1234, the second word may be 0xDCBA_{—}5678, and the least significant word may be 0xFEDC_{—}3456. The offset may be 16 bits, or 4 nibbles, where these 16 bits may be, for example, header information for the second PDU 610. The length of the payload in the second PDU 610 may be 64 bits. Accordingly, the packed data of the second PDU 610 may comprise the 4 least significant nibbles of the most significant word, the next word, and the 4 most significant nibbles of the last word. The packed data may be 64 bits in length, 0x1234_DCBA_{—}5678_FEDC.

Accordingly, when both PDUs are stripped of headers and packed, the resulting data may be 148 bits in length, 0xCD43_{—}21BE_AC87_{—}65ED_FA65_{—}4123_{—}4DCB_A567_{—}8FED_C. However, since the packed data for both PDUs may not end on a word boundary, the last word may be padded with zeros to end the packed data on a word boundary. Accordingly, the final packed data may be 0xCD43_{—}21BE_AC87_{—}65ED_FA65_{—}4123_{—}4DCB_A5678FED_C000.

At time instant T0, the first word, 0xABCD_{—}4321, may be loaded into the first pipeline state 620. However, since the payload has an offset of 8 bits, the first 8 bits may be don't cares. For convenience, those 8 bits may be thought of as zeros. Accordingly, the most significant word may be loaded with the first 2 nibbles as zeros, for example, 0x00CD_{—}4321. At time instant T1, the first word may be shifted left by the number of offset bits and loaded to the second pipeline stage 622, while the next word, 0xBEAC_{—}8765, may be loaded to the first pipeline stage 620. Accordingly, the word in the second pipeline stage 622 may be 0xCD43_{—}2100, where zeros may have been shifted in for the least significant 2 nibbles.

At time instant T2, a copy of the word in the first pipeline stage 620, 0xBEAC_{—}8765, may be shifted right by 24 bits in order to move the most significant 8 bits to the least significant 8 bit position, resulting in 0x0000_{—}00BE. The 24 bits to shift may be calculated as N=(32−total_offset), where N may be the number of bits to shift right and total_offset is the offset in bits. The total_offset may be 8 bits, or 2 nibbles. The shifted right word may be logically ORed with the word in the second pipeline stage 622, 0xCD43_{—}2100, to result in 0xCD43_{—}21BE. This logically ORed word may be stored in the third pipeline stage 624. The word in the first pipeline stage, 0xBEAC_{—}8765, may be shifted left by the offset number of bits and stored in the second pipeline stage 622. The word in the second pipeline stage 622 may now be 0xAC87_{—}6500. The third word of the first PDU 600 may be loaded into the first pipeline stage 620. However, since only the first 7 nibbles may be needed, the last nibble may be a zero. The word loaded into the first pipeline stage 620 may be 0xEDFA_{—}6540.

At time instant T3, the word in the third pipeline stage 624 may be transferred to the data FIFO block 216. The third pipeline stage 624 may be filled with a new word following a similar process as at the time instant T2. The word in the third pipeline stage 624 may be 0xAC87_{—}65ED. Similarly, the word in the first pipeline stage 620 may be shifted left by the number of offset bits and stored in the second pipeline stage 622. This number may be 0xFA65_{—}4000. The third zero may result from the last nibble of the first data set 600 that was not used. This may also increase the total_offset by 4 to a value of 12. Accordingly, 3 nibbles may need to be logically ORed with the word in the second pipeline stage 622.

Since all of the specified data in the first PDU 600 may have been used, data from the second PDU 610 may need to be used. Accordingly, the most significant word of the second PDU 610 may be loaded into the first pipeline stage 620. The data in the first pipeline stage 620 may be 0x0000_{—}1234. The first 4 nibbles of this word may be zeros since the offset may be 16 bits. Therefore, the total_offset may now be 7 nibbles.

At time instant T4, the word in the third pipeline stage 624 may be transferred to the data FIFO block 216. The third pipeline stage 624 may hold the word 0xFA65_{—}4123, which may be the result logically ORing a copy of the word in the first pipeline stage 620 shifted right appropriately with the word in the second pipeline stage 622. The number of bits to shift right may be 8 nibbles minus 7 nibbles, which may be 1 nibble, or 4 bits. Accordingly, 0x0000_{—}0123 may be logically ORed with 0xFA65_{—}4000 to result in 0xFA65_{—}4123. The second pipeline stage 622 may hold the word 0x0000_{—}1234 shifted left by 7 nibbles, or 0x4000_{—}0000. The first pipeline stage 620 may hold the second word 0xDCBA_{—}5678 of the second PDU 610.

At time instant T5, the word in the third pipeline stage 624 may be transferred to the data FIFO block 216. The third pipeline stage 624 may hold the word 0x4DCB_A567. This word may be a result of logically ORing the word in the first pipeline stage 620 shifted right by 1 nibble with the word in the second pipeline stage 622. The second pipeline stage 622 may hold the word 0xB000_{—}0000, which may be a result of shifting left the word from the first pipeline stage 620 by 7 nibbles. The first pipeline stage 620 may hold the word 0xFEDC_{—}0000, which may be the least significant word of the second PDU 610, where the least significant 4 nibbles may have been replaced with zeros.

At time instant T6, the word in the third pipeline stage 624 may be transferred to the data FIFO block 216. The third pipeline stage may then store the word 0x8FED_C000. This may be a result of right shifting the word in the first pipeline stage 620 by 1 nibble and logically ORing the result with the word in the second pipeline stage 622. Since there are no more words in the second PDU 610 to pack, and there are no more PDUs to pack, the word in the third pipeline stage 624 may be transferred into the data FIFO block 216 at time instant T7.

Although an embodiment of the invention may have been described using nibble offsets and nibble boundary data size for ease of explanation, the invention also applies to bit offsets and bit boundary data sizes.

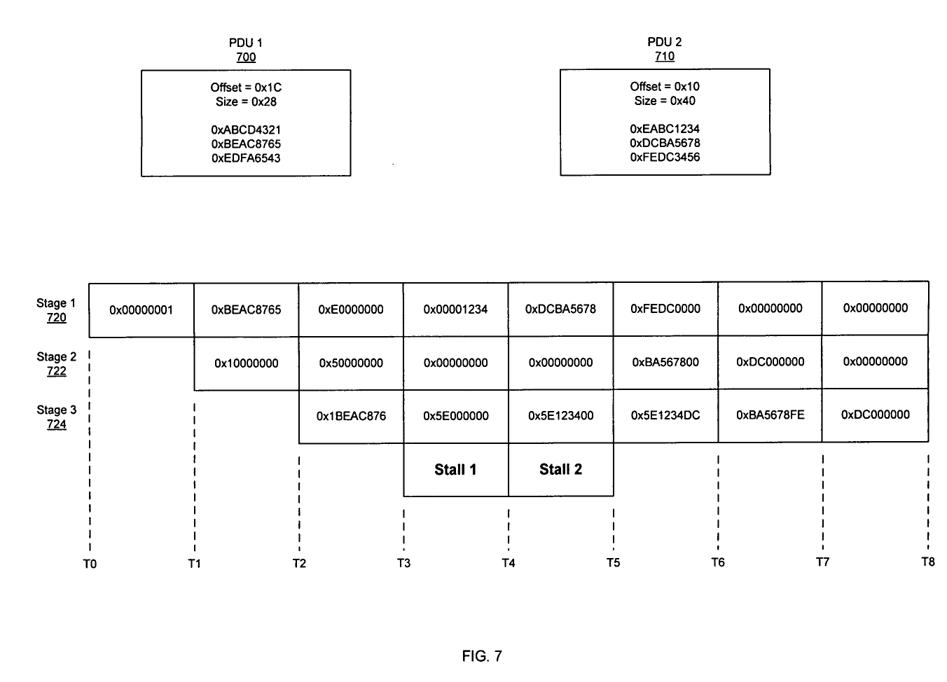

FIG. 7 is a diagram illustrating exemplary pipeline stages for packing data with stalls, in accordance with an embodiment of the invention. Referring to FIG. 7, there is shown a first PDU 700, a second PDU 710, and three pipeline stages 720, 722, and 724. The pipeline stages 720, 722, and 724 may be a portion of the packing module 214. There is also shown time instants T0, . . . , T8 at which various actions may occur with respect to the pipeline stages 720, 722, and 724. These time instants may, for example, coincide with rising edges and/or falling edges of clock signals.

In an exemplary embodiment of the invention, the first PDU 700 may comprise three 32-bit words, where the most significant word may be 0xABCD_{—}4321, the second word may be 0xBEAC_{—}8765, and the least significant word may be 0xEDFA_{—}6543. The underscore is placed after every 4 nibbles for ease of reading the hexadecimal characters and has no other significance. The offset may be 28 bits, or 7 nibbles, where these 28 bits may be, for example, header information for the first PDU 700. The length of the payload in the first PDU 700 may be 40 bits. Accordingly, the packed data of the first PDU 700 may comprise the least significant nibble of the most significant word, the next word, and the most significant nibble of the last word. The packed data may be 40 bits in length, 0x1BEA_C876_{—}5E.

The second PDU 710 may also comprise three 32-bit words, where the most significant word may be 0xEABC_{—}1234, the second word may be 0xDCBA_{—}5678, and the least significant word may be 0xFEDC_{—}3456. The offset may be 16 bits, or 4 nibbles, where these 16 bits may be, for example, header information for the second PDU 710. The length of the payload in the second PDU 710 may be 64 bits. Accordingly, the packed data of the second PDU 710 may comprise the 4 least significant nibbles of the most significant word, the next word, and the 4 most significant nibbles of the last word. The packed data may be 64 bits in length, 0x1234_DCBA_{—}5678_FEDC. Accordingly, when both PDUs are stripped of headers and packed, the resulting data may be 148 bits in length, and may be the following value: 0x1BEA_C876_{—}5E12_{—}34DC_BA56_{—}78FE_DC. However, since the packed data may not align on a word boundary, the last word may be padded with zeros to align the packed data to word boundary. Accordingly, the final packed data may be 0x1BEA_C876_{—}5E12_{—}34DC_BA56_{—}78FE_DC00_{—}0000.

At time instant T0, the first word, 0xABCD_{—}4321, may be loaded into the first pipeline state 720. However, since the payload has an offset of 28 bits, the first 28 bits may be don't cares. For convenience, those 28 bits may be thought of as zeros. Accordingly, the most significant word may be loaded with the first 7 nibbles as zeros, for example, 0x0000_{—}0001. At time instant T1, the first word may be shifted left by the number of offset bits and loaded to the second pipeline stage 722, while the next word, 0xBEAC_{—}8765, may be loaded to the first pipeline stage 720. Accordingly, the word in the second pipeline stage 722 may be 0x1000_{—}0000, where zeros may have been shifted in for the least significant 7 nibbles.

At time instant T2, a copy of the word in the first pipeline stage 720, 0xBEAC_{—}8765, may be shifted right by 4 bits in order to move the most significant 28 bits to the least significant 28 bit position, resulting in 0x0BEA_C876. The number of bits to shift right may be calculated as N=(32−total_offset), where N may be the number of bits to shift right and total_offset is the offset in bits. The total_offset may be 28 bits, or 7 nibbles. The shifted right word may be logically ORed with the word in the second pipeline stage 722, 0x1000_{—}0000, to result in 0x1BEA_C876. This logically ORed word may be stored in the third pipeline stage 724. The word in the first pipeline stage, 0xBEAC_{—}8765, may be shifted left by the offset number of bits and stored in the second pipeline stage 722. The word in the second pipeline stage 722 may now be 0x5000_{—}0000. The third word of the first PDU 700 may be loaded into the first pipeline stage 720. However, since only the most significant nibble may be needed, the last 7 nibbles may be zeros. The word loaded into the first pipeline stage 720 may be 0xE000_{—}0000.

At time instant T3, the word in the third pipeline stage 724 may be transferred to the data FIFO block 216. A copy of the word in the first pipeline stage 720, 0xE000_{—}0000, may be shifted right by 4 bits and logically ORed with the word presently in the second pipeline stage 722, resulting in 0x5E00_{—}0000. Accordingly, the word 0x5E00_{—}0000 may be stored in the third pipeline stage 724. Since there are less than 32 valid bits, and there are other words to be packed, there may be a stall. A stall may occur when data in the third pipeline stage may retain the stored word until all of the 32 bits are valid. Accordingly, the word in the third pipeline stage 724 may not be transferred to the data FIFO block 216 at the next clocking signal, for example, the time instant T4.

The word 0xE000_{—}0000 may be shifted left by the total_offset of 28 bits. Therefore, the value of 0x0000_{—}0000 may be stored in the second pipeline stage 722. Since the last 7 nibbles of the last word in the first PDU may not be used, the total_offset may increase by 28 to a value of 56. However, since the pipeline handles 32-bit words, the effective offset may be 56 modulo 32, or 24 bits.

Since all of the specified data in the first PDU 700 may have been packed, the most significant word of the second PDU 710 may be loaded into the first pipeline stage 720. However, because the offset for the second PDU 710 may be 16 bits, the first 16 bits of the most significant word may be zeros. Therefore, the word in the first pipeline stage 710 may be 0x0000_{—}1234. Additionally, the total_offset may be increased by 16 bits to 40 bits. But, since the pipeline works on 32-bit words, the effective total_offset may be 40 modulo 32, or 8 bits.

At time instant T4, since the pipeline is stalled, the word in the third pipeline stage 724 may not be transferred to the data FIFO block 216. The word in the first pipeline stage 720, 0x0000_{—}1234, may be left circularly shifted by the total_offset number of bits, or 8 bits, to result in 0x0012_{—}3400. This word may then be masked to clear the bit positions that may correspond to valid data in the word in the third pipeline stage 724. Since the 2 most significant nibbles may be valid, the masked word may be 0x0012_{—}3400. The masked word may then be logically ORed with the word in the third pipeline stage 724 and stored in the third pipeline stage 724. Accordingly, the word in the third pipeline stage 724 may be 0x5E12_{—}3400. Since there may still be words to be packed, and the third pipeline state 724 does not have 32 valid bits, the pipeline may still be stalled.

The word in the first pipeline stage may be shifted left by the total_offset number of bits, which may be 8 bits, to result in 0x0012_{—}3400. However, because the pipeline stalled, this may be masked to clear the bit positions that correspond to the valid data in the word stored in the third pipeline stage 724. Accordingly, the most significant 6 nibbles may be cleared. The resulting word, which may be 0x0000_{—}0000, may be stored in the second pipeline stage 722. The first pipeline stage 720 may hold the second word 0xDCBA_{—}5678 of the second PDU 710.

At time instant T5, the pipeline stages may be stalled again. The word in the first pipeline stage 720 may be circularly shifted right by N=(32−total_offset) bits, or 24 bits to result in 0xBA56_{—}78DC. This word may then be masked to clear the bit positions that may correspond to valid data in the word in the third pipeline stage 724. Since the 6 most significant nibbles of the word in the third pipeline stage 724 may be valid, the result may be 0x0000_{—}00DC. The masked word may then be logically ORed with the word in the third pipeline stage 724 and stored in the third pipeline stage 724. Accordingly, the word in the third pipeline stage 724 may be 0x5E12_{—}34DC where all bits may be valid. Accordingly, the pipeline may not be stalled any more.

The word in the first pipeline stage may be shifted left by the total_offset number of bits, which may be 8 bits, to result in 0xBA56_{—}7800. The resulting word may be stored in the second pipeline stage 722. The first pipeline stage 720 may hold the third word 0xFEDC_{—}0000 of the second PDU 710. The least significant 4 nibbles may not be used since the length of data indicates that only the most significant 4 nibbles of the third word of the second PDU 710 may be used.

At time instant T6, the word in the third pipeline stage 624 may be transferred to the data FIFO block 216. The words in the first and second pipeline stages 720 and 722, respectively, may result in the word 0xBA56_{—}78FE, which may be stored in the third pipeline stage 724. The word 0xDC00_{—}0000 may be stored in the second pipeline stage 722. Since there are no more words to pack in the second PDU 710, and there are no more PDUs, zeros may be stored in the first pipeline stage 720.

At the time instant T7, the pipeline may be flushed. Accordingly, the word in the third pipeline stage 724 may be transferred to the data FIFO block 216. The word 0xDC00_{—}0000 in the second pipeline stage 722 may be stored in the third pipeline stage 724, and the first and second pipeline stages may store zeros. At the time instant T8, the pipeline may be flushed to transfer the last valid data to the data FIFO block 216.

Although an embodiment of the invention may have been described using nibble offsets and nibble boundary data size for ease of explanation, the invention also applies to bit offsets and bit boundary data sizes.

In accordance with an embodiment of the invention, aspects of an exemplary system may comprise a data packing block 200 that enables packing of payload bits for HSDPA packets. The HSDPA packet may be processed in sequence to form a data packet that is aligned to start on a n-bit boundary. Each word in the data packet may comprise n bits, where n may be a multiple of 8. For example, the n-bit words may be 32 bits in size. The payload bits for the HSDPA packets may be start at any bit position since, for example, a header at the beginning of each HSDPA packet may vary in size from packet to packet.

The data packing block 200 may enable insertion of bits at end of the data packet in order to pad the data packet to a n-bit boundary. This may be accomplished by the packing module 214, for example. The inserted bits may, for example, comprise zeros. The HSDPA packets may be fetched from memory by the bus master block 210, which may be enabled to perform direct memory accesses in burst transfer modes. The information for fetching the HSDPA packets may be stored in a linked list, where each member of the linked list may comprise information for one HSDPA packet.

The data packing block 200 may comprise a state machine block 212 that enables controlling of operation of the packing. The data packing block 200 may utilize a clocking signal to provide timing. The period of a state may be one-half of a period of the clocking signal or one period of the clocking signal. A n-bit word may be generated during a state period from the payloads of the HSDPA packets. A n-bit packed word may be generated per state period after pipeline stages of the packing module 214 are loaded. However, if the payloads in the HSDPA packets are such that stalls occur in the packing module 214, more than one state period may be required to generate a n-bit packed word may not be generated in one state period. This is explained in more detail with respect to FIG. 7.

Although embodiments of the invention may have been described with padding to end the packed data packet on a word boundary, the invention need not be so limited. For example, the padding may not be made, and the packed data packet may not end on a word boundary.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will comprise all embodiments falling within the scope of the appended claims.

What is claimed is:

1. A method for processing data at a mobile terminal, the method comprising packing payload bits for HSDPA packets in sequence, in hardware, to form at least one data packet that is aligned to start on a n-bit boundary, regardless of bit position of a start of a payload, wherein n is a multiple of 8.

2. The method according to claim 1, further comprising inserting bits to end of said data packet to pad said data packet to a n-bit boundary.

3. The method according to claim 2, wherein said inserted bits comprise zeros.

4. The method according to claim 1, further comprising fetching said HSDPA packets via direct memory access.

5. The method according to claim 1, further comprising fetching said HSDPA packets via variable size burst access.

6. The method according to claim 1, further comprising controlling operation of said packing via a state machine.

7. The method according to claim 1, further comprising generating a packed n-bit word during a state period.

8. The method according to claim 7, wherein said state period is one-half of a clock period.

9. The method according to claim 7, wherein said state period is one clock period.

10. The method according to claim 1, further comprising storing information for accessing said HSDPA packets in a linked list.

11. The method according to claim 1, wherein value of said n is 32.

12. The method according to claim 1, wherein said hardware comprises a multistage pipeline for packing said payload bits.

13. A system for processing data at a mobile terminal, the system comprising circuitry that enables packing of payload bits for HSDPA packets in sequence to form at least one data packet that is aligned to start on a n-bit boundary, regardless of a bit position of a start of a payload, wherein n is a multiple of 8.

14. The system according to claim 13, further comprising said circuitry that enables insertion of bits to end of said data packet to pad said data packet to a n-bit boundary.

15. The system according to claim 14, wherein said inserted bits comprise zeros.

16. The system according to claim 13, further comprising direct memory access circuitry that enables fetching of said HSDPA packets.

17. The system according to claim 16, further comprising said direct memory access circuitry that enables fetching of said HSDPA packets via a variable size burst access.

18. The system according to claim 13, further comprising a state machine that enables controlling of operation of said packing.

19. The system according to claim 13, wherein said circuitry generates a packed n-bit word during a state period.

20. The system according to claim 19, wherein said state period is one-half of a clock period.

21. The system according to claim 19, wherein said state period is one clock period.

22. The system according to claim 13, wherein information for accessing said HSDPA packets is stored in a linked list.

23. The system according to claim 13, wherein value of said n is 32.

24. The system according to claim 13, wherein said hardware comprises a multistage pipeline for packing said payload bits.
